(19) United States
(12) Patent Application Publication
(10) Pub. No.: US 2004/0097676 A1
(43) Pub. Date: May 20, 2004

(54) Crosslinkable functional polymer which makes possible the manufacture of light-conducting materials

(75) Inventors: Bernard Boutevin, Montpellier (FR); Alain Rousseau, Montpellier (FR); Jean-Marc Sage, Oullins (FR)

Correspondence Address: HUNTON & WILLIAMS LLP, INTELLECTUAL PROPERTY DEPARTMENT, 1900 K STREET, N.W., SUITE 1200, WASHINGTON, DC, 20006-1109, US

(73) Assignee: Atofina

(21) Appl. No.: 10/299,059

(22) Filed: Nov. 19, 2002

(30) Foreign Application Priority Data
Nov. 19, 2002 (FR) 01.14940

(51) Int. Cl. C08F 114/18

(52) U.S. Cl. 526/249; 526/250; 526/266

(57) ABSTRACT

The present invention comprises a transparent and partially fluorinated polymer which comprises three repeat units resulting from industrial monomers which are simple to access and which has a glass transition temperature of greater than 25° C., which polymer makes possible the preparation of articles, in particular of articles acting as guide or conductor for light in the region of the wavelengths of visible or near infrared type. This polymer is of use in the manufacture of optical fiber.

### BACKGROUND OF THE INVENTION

This application claims benefit of priority to French Application No. 01.14940, filed Nov. 19, 2001, which is herein incorporated by reference in its entirety.

i. Field of the Invention

The subject-matter of the present invention is a transparent and partially fluorinated polymer with a glass transition temperature of greater than 25° C. which is manufactured from industrial monomers which are simple to access, which polymer makes possible the preparation of articles, in particular of articles acting as a guide or conductor for light in the region of the wavelengths of visible or near infrared type. This polymer is of use in the manufacture of optical fiber.

There is great interest in designing a polymer material having the properties necessary for producing optical fibers. Reference may be made, to this end, to the article “Polymeric Materials for Devices in Optical Fibre Systems” by Anthony R. Blythe and John R. Vinson (Polymers for Advanced Technologies, Vol. 11, p. 601-611, 2000).

ii. Description of the Related Art

Optical fibers are currently largely made of silica. They have major disadvantages in the achievement of connections over short distances. These disadvantages are due to the difficulty in establishing connections between the fibers themselves or between various devices and the fibers, and to the unreliability of these connections when they are established.

Poly(methyl methacrylate) (PMMA) has been used for the manufacture of optical fibers in order to facilitate connections between fibers but this polymer absorbs too strongly at the wavelengths employed in the use of optical fibers.

Perfluorinated polymers based on perfluorinated cyclic monomers are known for the manufacture of optical fibers. However, the synthesis of these perfluorinated cyclic monomers is problematic and requires the use of dangerous fluorinating agents, which greatly restricts their accessibility and results in a very high cost price for the polymer. In order to minimize the amount of polymer employed and therefore the cost, the diameter of the fibers has been reduced, rendering the connection between the fibers difficult to carry out.

Application EP-A1-990 509 discloses a process for the manufacture of optical fiber using an acrylate resin composed of partially fluorinated functional oligomers of acrylic type, which are difficult to synthesize, or of diacrylate linear perfluorinated polyether type exhibiting a very low glass transition temperature (Tg) and a limited degree of crosslinking, resulting in the need to add an at least partially fluorinated di- or trifunctional acrylate reactive diluent which is also difficult to synthesize.

As the glass transition temperature (Tg) is the temperature above which limited movements of the polymer chains are possible, its limitation reduces the thermal and mechanical stability of the optical fibers, just like the limitation on the degree of crosslinking. The thermal stability of an optical fiber therefore depends on the Tg and on the degree of crosslinking of the polymer used.

Application WO 00/27782 discloses functional oligomers, the structure of which is based on a chain of (CF₂—CFX)— repeat units in which X═F, Cl or Br and for which the glass transition temperature (Tg) is low and close to ambient temperature, not making it possible to ensure perfect stability of the optical properties under the conditions of use of the optical fibers.

In uses different from that envisaged by the Applicant Company, the document JP-11096832, which discloses a chlorotrifluoroethylene/vinylene carbonate/tbutyl allyl peroxycarbonate copolymer capable of thermally crosslinking, is known. This thermal crosslinking does not make it possible, however, to envisage a process for forming an optical fiber with a sufficient rate of crosslinking. Furthermore, this thermal crosslinking is accompanied by a loss in mass of the product, that is to say a release of molecules in the gaseous state, which will be harmful to the optical properties of the material by leading to microbubbles in the structure of the polymer.

The rate of crosslinking has to be fast in view of very high spinning rates necessary to provide for the industrial production of several million km/year of optical fibers. Chlorotrifluoroethylene/hydroxyethyl vinyl ether/triethylene glycol methyl vinyl ether polymers are also disclosed in this same application.

No polymer material is currently capable of being used satisfactorily in the manufacture of optical fiber. In particular, the fluorinated or partially fluorinated materials developed to date involve fluorinated monomers which are difficult to access, either because of the large number of stages necessary for their synthesis, or because of the use of fluorinating agents or because of their unsatisfactory thermal/mechanical properties.

### SUMMARY OF THE INVENTION

The Applicant Company has found a transparent functional polymer, of amorphous nature, which is capable of being rapidly rendered crosslinkable under UV radiation, which is soluble in the usual organic solvents, which has a glass transition temperature greater than ambient temperature and which results in reasonable manufacturing costs in comparison with the prior art. This polymer is obtained from the copolymerization of commercially available monomers not requiring the use of dangerous reactants for their conversion.

The introduction into the functional polymer of an ethylenic group renders it crosslinkable at any time by simple treatment with UV radiation.

The crosslinking of this functional copolymer in the presence of an initiator system according to processes already known and disclosed in the literature makes possible the preparation of optical components, such as optical fibers.

A subject-matter of the invention is a copolymer comprising at least three repeat units P1, P2 and P3 with the following general formulae:

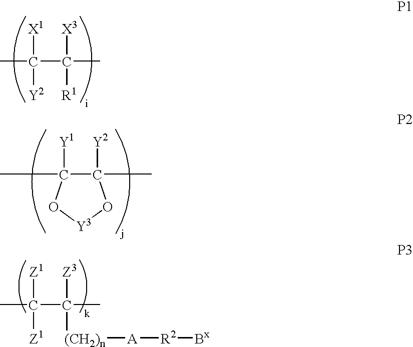

in which X¹, X² and X³, which are identical or different, are taken from the group of atoms H, F, Cl and Br; R¹ is an H, F, Cl or Br atom or a carbonaceous group comprising from 1 to 10 partially or completely fluorinated carbon atoms; Y¹ and Y², which are identical or different, are taken either from the group of atoms comprising H, F, Cl and Br or from the family of the carbonaceous groups comprising from 1 to 10 carbon atoms; Y³ is a carbonyl group or a divalent carbonaceous group; Z¹, Z² and Z³, which are identical or different, are hydrogen atoms or carbonaceous groups comprising from 1 to 10 carbon atoms; n is equal to 0 or 1; A is an ester functional group or an oxygen or sulfur atom; R² is taken from the group comprising of divalent hydrocarbonaceous groups with 2 to 8 carbon atoms and divalent carbonaceous groups with 2 to 8 carbon atoms which are partially halogenated; B^{X} is an atom, a group or a functional group; i, j, and k correspond to a repeat number of units; the content of P3 units in the copolymer being between 2 and 40 mol %, preferably between 10 and 20 mol %, and the molar ratio of the P1/P2 units being between 0.5 and 5.5, preferably between 1 and 2, the copolymer being transparent, of amorphous nature and having a glass transition temperature (Tg) greater than 25° C.

According to one embodiment of the copolymer, the Tg is between approximately 60 and 90° C. when the content of P2 units in the copolymer is between approximately 20 and 50 mol %.

According to an embodiment of the copolymer, its molecular mass (Mn) is between 500 and 10⁵, preferably between 10³ and 10⁴ and more particularly between 2×10³ and 5×10³.

According to an embodiment of the copolymer, the repeat unit P1 is a fluorinated ethylenic monomer M1 or results from the polymerization of at least two monomers M1 with the following general formula:

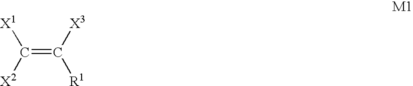

in which X¹, X² and X³, which are identical or different, are taken from the group of H, F, Cl and Br atoms; and R¹ is an H, F, Cl or Br atom or a carbonaceous group comprising from 1 to 10 partially or completely fluorinated carbon atoms.

According to an embodiment of the copolymer, M1 is tetrafluoroethylene (TFE) or chlorotrifluoroethylene (CTFE).

According to an embodiment of the copolymer, the repeat unit P2 is a monomer M2 or results from the polymerization of at least two monomers M2 with the following general formula:

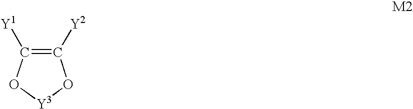

in which Y¹ and y², which are identical or different, are taken either from the group of atoms comprising H, F, Cl and Br or from the family of the carbonaceous groups comprising from 1 to 10 carbon atoms and y³ is a carbonyl group or a divalent carbonaceous group.

According to an embodiment of the copolymer, M2 is vinylene carbonate (VCA).

According to an embodiment of the copolymer, the repeat unit P3 is a monomer M3 or results from the polymerization of at least two monomers M3 with the following general formula:

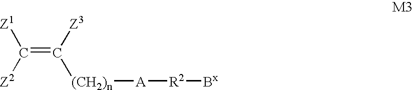

in which Z¹, Z² and Z³, which are identical or different, are hydrogen atoms or carbonaceous groups comprising from 1 to 10 carbon atoms; n is equal to 0 or 1; A is an ester functional group or an oxygen or sulfur atom; R² is taken from the group comprising of divalent hydrocarbonaceous groups with 2 to 8 carbon atoms and divalent carbonaceous groups with 2 to 8 carbon atoms which are partially halogenated; and B^{X} is an atom, a group or a functional group.

According to an embodiment of the copolymer, B^{X} is B¹, taken from the group comprising a chlorine, bromine or iodine atom, a hydroxyl functional group and a hydroxyl functional group modified by a protective group.

According to an embodiment of the copolymer, M3 is ethylene glycol vinyl ether (EGVE) or butanediol vinyl ether or their protective form.

According to an embodiment of the copolymer, the group B^{X} is a photocrosslinkable group B

According to an embodiment of the copolymer, B² is a group chosen from:

—O—CO—CH═CH₂, —O—CO—C(CH₃)═CH₂, —O—CH═CH₂ and —O—CH═CH—CH₃ (cis and trans).

The invention also relates to a manufactured article made of a material comprising a copolymer as described above.

The invention also relates to an optical fiber based on the copolymer as described above.

### DETAILED DESCRIPTION OF THE PREFERRED EMBODIMENTS

The functional copolymer according to the invention is composed of at least three repeat units P1, P2 and P3, represented below, resulting from the polymerization of the respective monomers M1, M2 and M3.

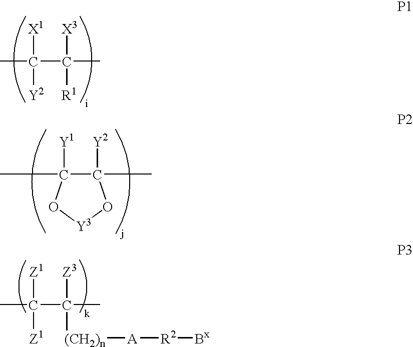

if j and k correspond to a repeat number of units.

The monomer M1, which gives rise to the repeat entities P1, is a monomer taken from the group of the completely or partially fluorinated or chlorofluorinated monomers with the general formula represented below:

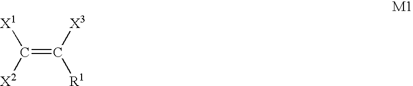

with the atoms X¹, X² and X³, which are identical or different, taken from the group of atoms consisting of H, F, Cl and Br and with R¹ being able to be an atom, in which case taken from the group of atoms consisting of H, F, Cl and Br, or being able to be a carbonaceous group comprising from 1 to 10 completely or partially fluorinated carbon atoms.

The repeat units P1 can result from one or more monomers of formula M1 taken from the group as described above. Preferably, the perfluorinated or chlorofluorinated monomers M1 will be chosen and particularly tetrafluoroethylene (abbreviated to TFE) and chlorotrifluoroethylene (abbreviated to CTFE). By way of example, M1 can also be a compound in which X¹═X²=X³═F and R¹═H, or a compound in which X¹═X²=H and X³═R¹=F, or a compound in which X¹═X²=X¹═F and R¹═CF₃.

The monomer M2, which gives rise to the repeat units P2, is a monomer with a cyclic structure of general formula:

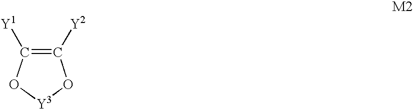

with Y¹ and Y², which are identical or different, taken either from the group of atoms consisting of H, F, Cl and Br or from the family of the carbonaceous groups comprising from 1 to 10 carbon atoms. Mention may be made, by way of example, of the compounds in which Y¹═Y²═F, in which Y¹═H and Y²═Cl, in which Y¹═H and Y²═F and in which Y¹═Cl and Y²═Cl.

Y³ is either a carbonyl group or a divalent carbonaceous group, such as, for example: —CH₂—, —CH(CH₃)— and —C(CH₃)₂—. Preferably, the monomer M2 is vinylene carbonate (VCA), in which Y³ is a carbonyl group and Y¹ and Y² are hydrogen atoms.

The repeat units P3 result from the monomer M3 represented by the following general formula:

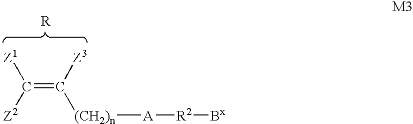

in which Z¹, Z² and Z³ are identical or different. Z¹, Z² and Z³ are either an H atom or are taken from the group consisting of the carbonaceous groups comprising from 1 to 10 carbon atoms; n is equal to 0 or 1; A is either an ester functional group such that M3 corresponds to one of the two formulae M3′ and M3″ below:

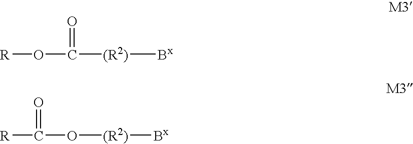

or an atom taken from the group consisting of oxygen and sulfur; R² is taken from the group consisting of divalent alkyl groups comprising 2 to 8 carbon atoms and divalent alkyl groups comprising 2 to 8 carbon atoms which are partially halogenated by F and/or Cl; and B^{X} is B¹ taken from the group consisting of a Cl, Br or I atom, a hydroxyl functional group and a hydroxyl functional group modified by a protective group which can, for example, be a trimethylsilane group or a mesityl group.

More particularly, preference is given to the monomers M3 for which Z¹, Z² and Z³ are hydrogen atoms, n=0, A is an oxygen atom, R² is a linear hydrocarbonaceous chain comprising 2 to 4 carbon atoms and B¹ is a primary alcohol functional group or a primary alcohol functional group modified by a protective group, such as the trimethylsilane or mesityl group.

After copolymerization of the monomers M3, it is possible to convert the group B¹ of the monomers M3 of the copolymer, by one or more chemical reactions known to a person skilled in the art, to a group B² of (meth)acrylate or vinyl ether type which can be crosslinked under UV radiation, leading to the production of the unit P3.

B² is a group taken from:

—O—CO—CH═CH₂, —O—CO—C(CH₃)═CH₂, —O—CH═CH₂ and —O—CH═CH—CH₃ (cis and trans).

The conversion of the group B¹ of the polymer obtained on conclusion of the polymerization of the monomers M1, M2 and M3 to an acrylate functional group, when B¹ is a hydroxyl functional group, can be obtained according to the conventional routes of organic synthesis starting from acid chlorides or from anhydrides, or else by transesterification reaction with a methyl or ethyl (meth)acrylate, or else by direct reaction of the acid with the alcohol B¹, with the removal of the water formed.

Use may be made, as process which makes it possible to obtain the polymer, of any polymerization process known to a person skilled in the art: in solvent medium, in aqueous suspension or in emulsion in water, for example. It will generally be preferable to operate in a solvent medium, in order to control the exothermicity of the polymerization and to promote intimate mixing of the various monomers. Mention may be made, among solvents commonly used, of: ethyl, methyl or butyl acetate or chlorinated or chlorofluorinated solvents, such as, for example, F141b® (CFCl₂—CH₃) or CF₃—CH₂—CF₂—CH₃.

Use may be made, as polymerization initiator, of free radical generators, such as peroxides, hydroperoxides, percarbonates or azo compounds, such as azoisobutyronitrile (AIBN) or its functionalized derivatives, subsequently making it possible to introduce an acrylate functionality at the chain end. Use may also be made, in the case of processes carried out in an aqueous medium, of inorganic free radical generators, such as persulfates or “redox” combinations.

In order to have better control over the composition of the polymer, it is also possible to introduce, in all or in part, the monomers and the polymerization initiator continuously or portionwise during the polymerization. The polymerization temperature is generally dictated by the rate of decomposition of the initiator system chosen and is generally between 0 and 200° C., more particularly between 40 and 120° C. The pressure is generally between atmospheric pressure and a pressure of 50 bars, more particularly between 2 and 20 bars.

The reaction can be carried out in the presence of a stabilizer of the functional monomer M3, without prejudicing the invention. When this monomer comprises: A an oxygen atom, n=0, B¹ a primary alcohol functional group, a stabilizer can be employed in order to prevent a side reaction in the monomer M3 which leads to its decomposition. The stabilizers are compounds of hydrogen- or dihydrogenphosphate or hydrogencarbonate type or any other compound of epoxide type which is capable of preventing this side reaction. This stabilizer is present in amounts of the order of 0.01 to 10 mol % with respect to the monomer M3. In order to prevent this side reaction in the monomer M3, it is also possible to protect the primary alcohol functional group B¹ beforehand with a protective group of trialkylsilyl or mesityl type by employing methods known in the field of chemistry.

After polymerization of the comonomers M1, M2 and M3, the primary alcohol functional group is reestablished by treatment with a compound exhibiting a labile hydrogen (H₂Oor CH₃OH, for example).

The molecular mass of the copolymer is controlled by controlling the length of the chain of the copolymer. The aim of this control is to make it possible to adjust the solubility of the copolymer chain in an acrylic reactive diluent or solvent and also to control the final viscosity of this mixture in order to obtain viscosity values compatible with the subsequent process for making use of the copolymer.

In order to control the length of macromolecular chains comprising the entities P1, P2 and P3, an agent known as a chain-limiting agent or transfer agent, the use of which is well known in polymerization chemistry can be added during the copolymerization of the monomers M1, M2 and M3. The solvent used can also have a chain-limiting role, depending on its chemical nature. Mention may be made, among chain-limiting agents known to a person skilled in the art, of, for example, halogenated derivatives, such as CCl₄ or CHCl₃, phosphites, such as H—PO(OEt)₂, alcohols or ethers having hydrogens on the carbon alpha to the oxygen atom, or esters, such as ethyl acetate.

The polymer according to the invention has a molecular mass (Mn) of between 500 and 10⁵, preferably between 10³ and 10⁴ and very particularly between 2×10³ and 5×10.

The content of functional units P3 in the copolymer comprising the units P1, P2 and P3, that is to say the molar percentage expressed by (k/(i+j+k)×100), can vary between 2 and 40 mol % and preferably between 10 and 20 mol %. This content determines the degree of crosslinking when the copolymer is made use of.

The ratio of the units P1/P2, that is to say the ratio (i/j), can vary from 0.5 to 5.5 and is preferably between 1 and 2. This ratio, and more particularly the content of P2 units, influences the glass transition temperature (Tg) of the polymer.

The invention will now be illustrated by presenting examples of the implementation of the invention.

The following abbreviations correspond to:

| | |
|---|---|
| CTFE: | Chlorotrifluoroethylene CF₂═CFCl |
| EGVE: | Ethylene glycol vinyl ether |
| | CH₂═CH—O—CH₂—CH₂—OH |
| EGVE-TMS: | CH₂═CH—O—CH₂—CH₂—O—Si(CH₃)₃ |
| BDVE: | Butanediol vinyl ether or HBVE for |
| | 4-hydroxybutyl vinyl ether |
| | CH₂═CH—O—CH₂—CH₂—CH₂—CH₂—OH |
| VCA: | Vinylene carbonate |

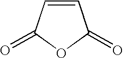

| | |
|---|---|
| TBPP: | tert-Butyl perpivalate, at 75% in isododecane |
| EMHQ: | 4-Methoxyphenol |
| DAROCUR: | 2-Hydroxy-2-methylpropiophenone |
| 117369 ®: | |
| Tg: | Glass transition temperature |
| Mn: | Molecular mass |

The number-average molecular masses (Mn) are determined by SEC (steric exclusion chromatography) analysis. A device from Spectra Physic, “Winner Station”, is used. Detection is carried out by refractive index. The column is a 5-micron mixed C PL, gel column from Polymer Laboratory and the solvent used is THF at a flow rate of 0.8 ml/min. The number-average molecular masses (Mn) are expressed in g/mol in comparison with a polystyrene standard.

The glass transition temperatures (Tg) are determined by differential scanning calorimetry (DSC). A first rise in temperature at 20° C./min is carried out, followed by cooling and then a second rise in temperature, during which the glass transition temperatures (Tg) or the melting temperatures (Tm), depending on the situation, are recorded. The temperature range is either from −20° C. to 80° C., if the Tg is less than 60° C., or from 50° C. to 200° C., if the Tg is greater than 60° C.

The chlorine levels are determined conventionally by ashing in a Parr bomb and then quantitatively determining the chlorides by argentometry.

The hydroxyl functional groups are quantitatively determined by the method of Bryant et al. (J. Am. Chem. Soc., Vol. 62, 1, 1940) described by Stig Veibel in “The Determination of Hydroxyl Groups”, edited by R. Belcher and D. M. W. Anderson, Academic Press, London and New York, 1972 (pp. 86 and 129). The alcohol functional groups are acetylated with a BF₃/CH₃COOH complex and then the water formed is back titrated by potentiometric titration of Karl Fischer type. The solvent, para-dioxane, cited in the method was replaced by acetonitrile. The results are expressed in milliequivalents of OH functional group per gram of polymer (meq/g).

Use is made, for the UV irradiation, of a Fusion UV LC-6 conveyor equipped with a Fusion F300S UV treatment system which has a “bulb H” lamp of 214 W (wavelength of 351 to 400 nm). The rate of forward progression of the conveyor corresponds to an exposure time to ultra-violet radiation of 300 ms for one pass.

Comparative 1

[CTFE/EGVE:M1/M3]

The polymerization is carried out in a 160 ml stainless steel reactor. Once the reactor has been closed, two to three purges are carried out with 5 bars of nitrogen. The reactor is then placed under vacuum (approximately 100 mbars) and 50 ml of an ethyl acetate solution, comprising 0.4 ml of TBPP initiator (1.5 mmol) and 3.8 g of EGVE (M3; 43 mmol), are subsequently introduced by suction. 5 g of CTFE (M1; 43 mmol) are subsequently introduced. The reactor is closed and the temperature is brought to 70° C. for 4 h with stirring; the initial pressure is approximately 5 bars. After the reaction, the contents of the autoclave are evaporated until a volume of approximately 10-20 ml is obtained and then the reaction mass is precipitated with n-heptane. The precipitated copolymer is separated and then dried under vacuum.

2.6 g of a polymer are thus collected. The polymer has a pasty appearance and exhibits a Tg of less than 40° C.

### EXAMPLE 2

[CTFE/VCA/EGVE-TMS:M1/M2/M3 in Ethyl Acetate]

The polymerization is carried out in a 160 ml stainless steel reactor. The reactor is closed and then two to three purges are carried out with 5 bars of nitrogen. The reactor is then placed under vacuum (approximately 100 mbars) and 50 ml of an ethyl acetate solution, comprising 0.4 ml of TBPP initiator (1.5 mmol), 2.1 g of EGVE-TMS (M3; 13 mmol) and 2.6 g of VCA (M2; 30 mmol), are introduced by suction. 5 g of CTFE (M1; 43 mmol) are subsequently introduced. The reactor is closed and the temperature is brought to 70° C. for 4 h with stirring with an initial pressure of approximately 5 bars. After the reaction, the contents of the autoclave are evaporated until a volume of approximately 10-20 ml is obtained, and 50 ml of methanol are added to deprotect the alcohol functional group of P3. The reaction mass is left stirring for 12 h at ambient temperature, then it is again evaporated until a volume of approximately 20 ml is obtained and is precipitated with n-heptane. The precipitated copolymer P1/P2/P3 is separated and then dried under vacuum. 5 g of copolymer are thus obtained. The copolymer is soluble in the usual solvents (acetonitrile, THF).

The analyses of the copolymer obtained are reported below:

Molar ratio P2/P3 units, determined by ¹H NMR=0.20

Tg: 50° C.

Mn=7 900

A second experiment similar to that of Example 2 made it possible to measure a chlorine level of 18.0% with a comparable ratio of P2/P3 units (equal to 0.25), which results in a molar composition of P1/P2/P3 units for the copolymer for Example 2 estimated at 52/10/38.

### EXAMPLE 3

[CTFE/VCA/EGVE-TMS: M1/M2/M3 in Ethyl Acetate]

The polymerization is carried out in a 160 ml stainless steel reactor. The reactor is closed and then two to three purges are carried out with 5 bars of nitrogen. The reactor is then placed under vacuum (approximately 100 mbars) and 50 ml of an ethyl acetate solution, comprising 0.4 ml of TBPP initiator (1.5 mmol), 2.1 g of EGVE-TMS (M3; 13 mmol) and 5.03 g of VCA (M2; 58 mmol), are introduced by suction. 7 g of CTFE (M1; 60 mmol) are subsequently introduced. The temperature is brought to 70° C. for 4 h with stirring with an initial pressure of approximately 5 bars. After the reaction, the contents of the autoclave are evaporated until a volume of approximately 10-20 ml is obtained, and 50 ml of methanol are added to deprotect the alcohol functional group of P3. The reaction mass is left stirring for 12 h at ambient temperature and is then again evaporated until a volume of approximately 20 ml is obtained. It is precipitated with n-heptane. The precipitated copolymer P1/P2/P3 is separated and then dried under vacuum. 5 g of copolymer are thus obtained, which copolymer is soluble in the usual solvents (acetonitrile, THF).

The analyses of the copolymer obtained are reported below:

Molar ratio P2/P3 units, determined by ¹H NMR=1

Tg: 62° C.

Mn=5 700

[OH]=1.6 meq/g

### EXAMPLE 4

[CTFE/VCA/EGVE-TMS: M1/M2/M3 in F141®]

The polymerization is carried out in the same way as in Example 2 described above but using the solvent F141b® (CFCl₂—CH₃) in place of ethyl acetate. The amounts involved are 5.23 g of VCA (M2; 61 mmol), 4.2 g of EGVE-TMS (M3; 26 mmol), 0.4 ml of TBPP initiator (1.5 mmol) and 10 g of CTFE (M1; 86 mmol). 10.3 g of a transparent copolymer P1/P2/P3 are thus obtained, which copolymer is soluble in acetonitrile.

The analyses of the copolymer obtained are reported below:

Chlorine level by mass: 16.0%

Molar ratio VCA/EVGE (P2/P3 units) determined by ¹H NMR=0.83, i.e. a molar composition of P1/P2/P3 units estimated at 45/25/30.

Tg: 74° C.

[OH]=1.8 meq/g

### EXAMPLE 5

[CTFE/VCA/EGVE-TMS: M1/M2/M3 in F141b® with HPO (OEt)₂]

The polymerization is carried out in a 300 ml stainless steel reactor. The reactor is closed and then two to three purges are carried out with 5 bars of nitrogen. The reactor is then placed under vacuum (approximately 100 mbars) and 150 ml of an F14 lb® solution, comprising 1.5 ml of TBPP initiator (5.6 mmol), 12.6 of EGVE-TMS (M3; 78 mmol), 15.6 g of VCA (M2; 182 mmol) and 7.2 g of diethyl phosphite (52 mmol), are introduced by suction. 30.5 g of CTFE (M1; 257 mmol) are subsequently introduced. The reactor is closed and the temperature is brought to 70° C. for 4 h with stirring, the initial pressure being approximately 10 bars. After the reaction, the contents of the autoclave are evaporated until a volume of approximately 50 ml is obtained, and 100 ml of methanol are added to deprotect the alcohol functional group of P3. The reaction mass is left stirring for 2 h at ambient temperature and is then again evaporated, the residue is taken up with acetone (150 ml) and the product is precipitated by addition of water. The precipitated copolymer P1/P2/P3 is separated and then dried under vacuum.

46 g of colorless and transparent copolymer are thus obtained, which copolymer is soluble in the usual solvents (acetone, acetonitrile, THF).

The analyses are shown below:

Percentage of chlorine by mass: 17.1%

Molar ratio P2/P3, determined by ¹H NMR=2, which leads to the molar composition of P1/P2/P3 units estimated at 49/34/17.

Tg=75° C.

Mn=4.6×10³

[OH]=1.5 meq/g

The preceding results were collated in TABLE 1 below.

Comparative Example 10 is a copolymer resulting from the polymerization of CTFE (M1) and VCA (M2), with a molar ratio P1/P2=1.

TABLE 1

| | Molar ratio | Molar ratio | | |
|---|---|---|---|---|
| | P2/P3 | P1/P2 | Mn in g/mol | Tg in ° C. |
| Comparative | 0 | — | — | <40 |
| Example 1 | | | | |
| Example 2 | 0.2 | 5.2 | 7 900 | 50 |
| Example 3 | 1 | — | 5 700 | 62 |
| Example 4 | 0.8 | 1.8 | — | 74 |
| Example 5 | 2 | 1.4 | 4 600 | 75 |
| Comparative | — | 1 | — | 110-120 |
| Example 10 | | | | |

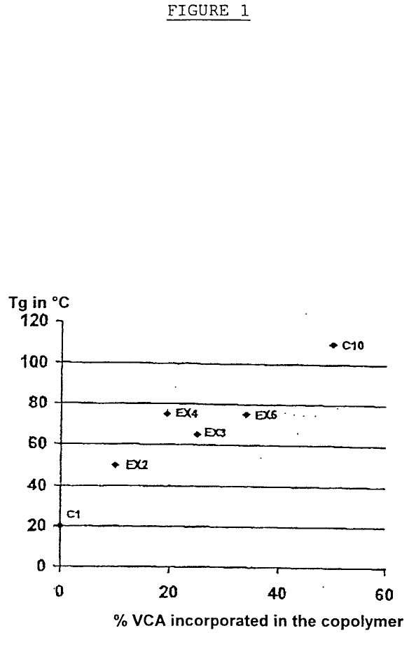

The graph in FIG. 1 represents the glass transition temperature (Tg) in ° C. as a function of the mol % of vinylene carbonate (VCA) incorporated in the copolymer according to the invention. It is found that the Tg increases with the % of VCA and that it is between approximately 60 and 90° C. where the content of P2 units is between approximately 20 and 50 mol %.

### Example 6

[Acrylation of the Primary Alcohol Functional Group of P3 with Acryloyl Chloride]

30 g of polymer prepared in Example 3 are dissolved in 90 ml of dry acetonitrile (water content less than 500 ppm) in a 250 ml glass reactor equipped with a drying tube filled with calcium chloride. 200 ppm of EMHQ are added, followed by the dropwise addition at 20° C. of 20 g of acryloyl chloride. The mixture is subsequently brought to 40° C. for 2 h. 5-10 ml of methanol are subsequently added and then the copolymer is precipitated from water. The copolymer thus obtained is dried and then redissolved in acetonitrile in order to be reprecipitated from water. After drying, 25 g of dry copolymer are obtained.

The infrared analysis shows the appearance of the characteristic acrylate bands.

### EXAMPLE 7

[CTFE/VCA/HBVE: M1/M2/M3 in F141b®]

1^{st} Stage: A solution composed of:

6.1 g of VCA (M2; 71 mmol);

2.8 g of diethyl phosphite (20.8 mmol);

5.7 g of HBVE (M3; 30.3 mmol), the alcohol functional group of which is protected with a trimethylsilane group. The 4-hydroxybutyl vinyl ether is prepared beforehand by reaction of the vinyl ether with hexamethyldisilazane.

1.5 g of TBPP initiator; and

80 ml of F141b® solvent;

is introduced into a stainless steel reactor.

12 g of CTFE (M1; 103 mmol) are subsequently introduced and the system is brought to 70° C. under autogeneous pressure for 4 hours with stirring. After the reaction, the contents of the autoclave are evaporated (30 mbars at ambient temperature). 250 ml of methanol are added to deprotect the alcohol functional group and the mixture is stirred for 2 hours. The reaction medium is again evaporated and purification is carried out by dissolution in acetonitrile and then precipitation with n-heptane. After drying under vacuum (20° C., 10 mbars), 20 g of a colorless oligomer are obtained, which oligomer is soluble in the usual solvents, such as acetone or THF.

¹H NMR analysis indicates a P2/P3 ratio of 1.5 and SEC analysis indicates an Mn=3 100 g/mol.

2^{nd} Stage: The acrylation is carried out as in Example 6 using 18.6 g of copolymer prepared above in Stage 1 in 55 ml of acetonitrile solvent and 9.9 g of acryloyl chloride (121 mmol) are used. After two purifications by dissolution in acetone and precipitation with water, 10 g of functionalized oligomer are obtained.

NMR analysis shows the formation of the acrylate functional groups, as does infrared analysis (1 720 cm⁻¹C═O, acrylate; 1 676 cm⁻¹, C═C, acrylate; 820 cm⁻¹, C═C, acrylate). SEC analysis indicates an Mn=4 800 g/mol.

3rd Stage: 1.98 g of the polymer of Stage 2 above are dissolved in 15 ml of 1,1,2-trichloroethane with 0.11 g of Darocur 1173® photoinitiator. Approximately 1 ml of this solution is deposited in an aluminium dish (diameter 5 cm) and then the solvent is evaporated in order to prepare a film. This film is then exposed to UV radiation. After three passes lasting 300 ms, the disappearance of the acrylate bands is observed by infrared analysis. The product thus obtained becomes insoluble in the usual solvents (acetone), which indicates crosslinking of the matrix.

A control reaction, carried out without photoinitiator, shows that the oligomer does not crosslink, the acrylate bands are still present in the infrared spectrum and the product remains soluble in acetone after UV exposure.

Likewise, a control carried out on this polymer shows that the acrylate bands remain stable at 54° C. for 4 h. This clearly demonstrates that the polymer crosslinks by photochemical initiation and not by a thermal or decomposition process.

### EXAMPLE 8

A mixture comprising, by mass, 50% of the polymer resulting from Stage 1 of Example 7 above and 50% of trifluoroethyl acrylate as reactive diluent is used. The two products form, as a mixture, a transparent and liquid resin. This mixture is dissolved in 1,1,2-trichloroethane in the presence of the same photoinitiator as in Stage 3 of Example 7. After a single pass under UV radiation for 300 ms, crosslinking, leading to the disappearance of the acrylate bands by infrared spectroscopy, and an insolubility of the product obtained after UV irradiation are observed.

What is claimed is:

1. A copolymer comprising at least three repeat units P1, P2 and P3 with the following general formula: 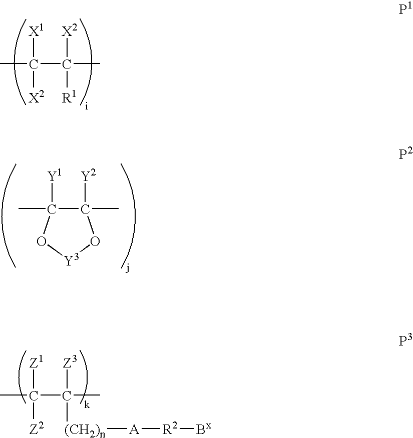
in which X¹, X², and X³, which are identical or different, are an H, F, Cl, or Br atom; R¹ is an H, F, Cl or Br atom or a carbonaceous group comprising from 1 to 10 partially or completely fluorinated carbon atoms; Y¹ and Y², which are identical or different, are either (i) H, F, Cl or Br atoms or (ii) a carbonaceous group comprising from 1 to 10 carbon atoms; Y³ is a carbonyl group or a divalent carbonaceous group; Z¹, Z² and Z³, which are identical or different, are hydrogen atoms or carbonaceous groups comprising from 1 to 10 carbon atoms; n is equal to 0 or 1; A is an ester functional group or an oxygen or sulfur atom; R² is a divalent hydrocarbonaceous group with 2 to 8 carbon atoms or a divalent carbonaceous group with 2 to 8 carbon atoms which are partially halogenated; B^{X} is an atom, a group or a functional group; i, j, and k correspond to a repeat number of units;
the content of P3 units in the copolymer being between 2 and 40 mol %, and the molar ratio of the P1/P2 units being between 0.5 and 5.5, the copolymer being transparent, of amorphous nature and having a glass transition temperature (Tg) greater than 25° C.

2. The copolymer according to claim 1, wherein the content of P3 units in the copolymer is between 10 and 20 mol %.

3. The copolymer according to claim 1, wherein the molar ratio of the P1/P2 units is between 1 and 2.

4. The copolymer according to claim 1, wherein Tg is between approximately 60 and 90° C. when the content of P2 units in the copolymer is between approximately 20 and 50 mol %.

5. The copolymer according to claim 1, wherein its molecular mass (Mn) is between 500 and 10⁵.

6. The copolymer according to claim 5, wherein Mn is between 10³ and 10⁴.

7. The copolymer according to claim 6, wherein Mn is between 2×10³ and 5×10³.

8. The copolymer according to claim 1, wherein the repeat unit P1 is a fluorinated ethylenic monomer M1 or results from polymerization of at least two monomers M1 with the following general formula: 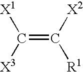
in which X¹, X², and X³, which are identical or different, are H, F, Cl or Br atoms, R¹ is an H, F, Cl or Br atom or a carbonaceous group comprising from 1 to 10 partially or completely fluorinated carbon atoms.

9. The copolymer according to claim 8 wherein M1 is tetrafluoroethylene (TFE) or chlorotrifluoroethylene (CTFE).

10. The copolymer according to claim 1, wherein the repeat unit P2 is a monomer M2 or results from the polymerization of at least two monomers M2 with the following general formula: 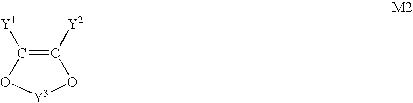
in which Y¹ and y², which are identical or different, are (i) H, F, Cl or Br atoms or (ii) a carbonaceous group comprising from 1 to 10 carbon atoms and Y³ is a carbonyl group or a divalent carbonaceous group.

11. The copolymer according to claim 6, wherein M2 is vinylene carbonate (VCA).

12. The copolymer according to claim 1, wherein the repeat unit P3 is a monomer M3 or results from polymerization of at least tow monomers M3 with the following general formula: 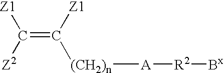
in which Z¹, Z² and Z³, which are identical or different, are hydrogen atoms or carbonaceous groups comprising from 1 to 10 carbon atoms; n is equal to 0 or 1, A is an ester functional group or an oxygen or sulfur atom, R² is a divalent hydrocarbonaceous group with 2 to 8 carbon atoms or a divalent carbonaceous group with 2 to 8 carbon atoms which are partially halogenated; and B^{X} is an atom, a group or a functional group.

13 The copolymer according to claim 8, wherein B^{x} is B¹ and is a chlorine, bromine or iodine atom, a hydroxyl functional group or a hydroxyl functional group modified by a protective group.

14. The copolymer according to claim 13, wherein M3 is ethylene glycol vinyl ether (EGVE) or butane-diol vinyl ether or their protective form.

15. The copolymer according to claim 12, wherein the group B^{x} is a photocrosslinkable group B².

16. The copolymer according to claim 15, wherein B² is: —O—CO—CH═CH₂;
—O—CO—C(CH₃)═CH₂; —O—CH═CH₂; or —O—CH═CH—CH₃ (cis or trans).

17. A manufactured article comprising the copolymer according to claim 1.

18. An optical fiber comprising the copolymer according to claim 1.
